(19) United States
(12) Patent Application Publication
(10) Pub. No.: US 2010/0315579 A1
(43) Pub. Date: Dec. 16, 2010

(54) COLORED LIQUID CRYSTAL DISPLAY

(75) Inventor: HERB HE HUANG, SHANGHAI (CN)

Correspondence Address: J C PATENTS, 4 VENTURE, SUITE 250, IRVINE, CA, 92618, US

(73) Assignee: JIANGSU LEXVU ELECTRONICS CO., LTD., JIANGSU (CN)

(21) Appl. No.: 12/815,059

(22) Filed: Jun. 14, 2010

Related U.S. Application Data
(60) Provisional application No. 61/268,878, filed on Jun. 16, 2009.

(51) Int. Cl. G02F 1/1335

(52) U.S. Cl. 349/113

(57) ABSTRACT

A colored liquid crystal display includes a transparent substrate, a transparent conductive layer, a planar liquid crystal cell, and a backplane substrate in sequence of receiving an incident light. The backplane substrate includes a first conductive reflector, a second conductive reflector and a third conductive reflector, tiled in a planar arrangement perpendicular to the incident light and electrically connected to a driving circuitry in the backplane substrate. The driving circuitry electrically drives the first conductive reflector, the second conductive reflector and the third conductive reflector individually as well as the transparent conductive layer to form spatially colored reflective light modulation.

### CROSS-REFERENCE TO RELATED APPLICATIONS

This application claims priority of provisional application No. 61/268,878, filed on Jun. 16, 2009, entitled “COLORED LIQUID CRYSTAL DISPLAY”, which is incorporated herein by reference in its entirety.

### FIELD OF THE TECHNOLOGY

The present invention generally relates to the technical field of spatial modulation display, and more particularly, to a colored liquid crystal display.

### BACKGROUND

In recent years, flat panel displays and liquid crystal displays (LCD) in particular, enabled by the optoelectronic technology and the integrated circuits technology, have become a mainstream of display devices. An LCD display has several advantageous features including thin-flat shape, lightweight, low operating voltage, low power-consumption, full colorization and low radiation, among others. The LCD display panels are classified into a transmission type, a reflective type and a transflective type according to their light-emitting mechanisms, wherein the reflective LCD displays include liquid crystal projectors and reflective liquid crystal on silicon (LCOS).

The basic planar components of an LCD panel include a top glass substrate with a transparent conductive film, a liquid crystal planar cell, a pixilated-electrode matrix backplane (transparent or reflective), at least one polarization film and a color filter array film made of polymeric materials containing color pigments and/or dye. Colorization is always one of the critical technical components to LCD and all of its subsidiary classes. The most commonly used colorization scheme is to use the pixilated-electrode matrix backplane to twist liquid crystal molecules in the liquid crystal planar cell so as to allow white light from a back light source to pass through the liquid crystal planar cell. Then RGB color filters in the color filter array film change the white light passing through the liquid crystal planar cell into colored lights so as to realize colorization. During colorization, the color filters in the existing color filter array film are required to accurately align with pixilated-electrodes in the pixilated-electrode matrix backplane, which increases complexity of LCD.

### SUMMARY

The present invention provides a colored LCD to decrease complexity of LCD.

An embodiment of the present invention provides a colored liquid crystal display. In an order of vertically receiving an incident light, the colored liquid crystal display includes a transparent substrate, a transparent conductive layer, a planar liquid crystal cell and a backplane substrate. The backplane substrate includes: a first conductive reflector, a second conductive reflector and a third conductive reflector, tiled in a planar arrangement perpendicular to the incident direction, adapted for reflecting the incident light passing through the transparent substrate and forming a first interference light in a first interference band, a second interference light in a second interference band, and third interference light in a third interference band respectively; and a driving circuitry electrically connected to the transparent conductive layer, the first conductive reflector, the second conductive reflector and the third conductive reflector, adapted for electrically charging the transparent conductive layer and each of the first conductive reflector, the second conductive reflector and the third conductive reflector individually and driving liquid crystal molecules in the planar liquid crystal cell to twist accordingly so as to allow the first interference light, the second interference light and the third interference light to irradiate out of the transparent substrate.

In the present invention, the colored liquid crystal display uses three conductive reflectors to perform spatially modulation by interfering reflective lights so as to realize colorization; therefore, there is no need to use the existing color filter array film and the requirement that the color filters shall accurately align with pixilated-electrodes in the pixilated-electrode matrix backplane does not exist accordingly, which decreases complexity of LCD.

### BRIEF DESCRIPTION OF THE DRAWINGS

The disclosure may be more completely understood in consideration of the following detailed description of various embodiments in connection with the accompanying drawings, in which:

FIG. 1 is a cross sectional view of the colored liquid crystal display according to an embodiment of the present invention;

FIG. 2 is a cross sectional view of the colored liquid crystal display 10 according to another embodiment of the present invention;

FIG. 3 is a cross sectional view of an improved structure of the colored liquid crystal display shown in FIG. 1;

FIG. 4 is a cross sectional view of an improved structure of the colored liquid crystal display shown in FIG. 2;

FIG. 5a illustrates the spectrum of the first interference light produced by the first conductive reflector of the colored liquid crystal display according to an embodiment of the present invention;

FIG. 5b illustrates the spectrum of the second interference light produced by the second conductive reflector of the colored liquid crystal display according to an embodiment of the present invention;

FIG. 5c illustrates the spectrum of the third interference light produced by the third conductive reflector of the colored liquid crystal display according to an embodiment of the present invention;

FIGS. 6a, 6b and 6c are top views of the conductive reflectors in the colored liquid crystal display in the present invention.

### DETAILED DESCRIPTION

The drawings for illustration are not necessarily to scale, emphasis instead being placed upon illustrating the framework and principles of the present invention. In the following description, reference is made to the accompanying drawings which form a part hereof, and which show, by way of illustration, a preferred embodiment of the present invention. It is understood that other embodiments may be utilized and structural changes may be made without departing from the scope of the present invention.

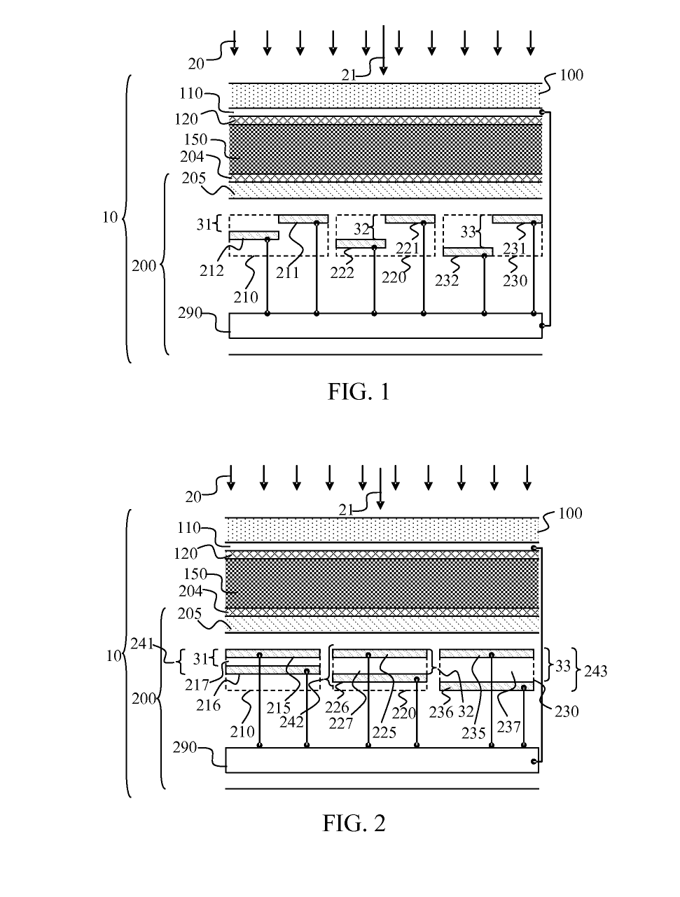

FIG. 1 is a cross sectional view of the colored liquid crystal display 10 according to an embodiment of the present invention. In the order of vertically receiving an incident light 20 along an incident direction 21, the colored liquid crystal display 10 includes the following planar constituents, all perpendicular to the incident direction 21: a transparent substrate 100, a transparent conductive layer 110, a planar liquid crystal layer 150 and a backplane substrate 200. The backplane substrate 200 includes a first conductive reflector 210, a second conductive reflector 220 and a third conductive reflector 230, tiled in a planar arrangement perpendicular to the incident direction 21, and a driving circuitry electrically connected to the transparent conductive layer 110, the first conductive reflector 210, the second conductive reflector 220 and the third conductive reflector 230.

During image display, the first conductive reflector 210, the second conductive reflector 220 and the third conductive reflector 230 reflect the incident light 20 passing through the transparent substrate 100 and form a first interference light in a first interference band 51, a second interference light in a second interference band 52, and third interference light in a third interference band 53 respectively. Meanwhile, the driving circuitry 290 electrically charges the transparent conductive layer 110 and each of the first conductive reflector 210, the second conductive reflector 220 and the third conductive reflector 230 individually so as to form corresponding electric field to drive liquid crystal molecules in the planar liquid crystal cell 150 to twist accordingly so as to allow the first interference light, the second interference light and the third interference light to irradiate out of the transparent substrate 100. The transparent conductive layer 110 made of indium-tin-oxide (ITO) or other optically transparent but electrically conductive films may control the magnitudes or durations of the charging performed by the driving circuitry 290.

Specifically, the first interference band 51, the second interference band 52 and the third interference band 53 correspond to absorption spectra of cyan, yellow and magenta, respectively so as to display colorful images based on a cyan, yellow and magenta (CYM) color model which is normally adopted in the 3-color printing industry. The CYM color model is spectrum complementary to the red, green and blue (RGB) color model which is normally used in existing LCD.

In the present embodiment, the colored liquid crystal display uses three conductive reflectors to perform spatially modulation by interfering reflective lights so as to realize colorization; therefore, there is no need to use the existing color filter array film and the requirement that the color filters shall accurately align with pixilated-electrodes in the pixilated-electrode matrix backplane does not exist accordingly, which decreases complexity of LCD.

Alternatively, as shown in FIG. 1, the first conductive reflector 210 includes a first high reflecting element 211 and a first low reflecting element 212, electrically connected to the driving circuitry 290, tiled in a planar configuration perpendicular to the incident direction 21 and vertically spaced in a first spacing 31 equal to m*[λ₁/4], wherein λ₁ is a first interference wavelength 41 centering the first interference band 51 and m is an odd integer. Thus, the first conductive reflector 210 through the first high reflecting element 211 and the first low reflecting element 212, produces destructive interference of the reflected portions to the incident light 20 of bandwidth defined by the first interference band 51 so as to produce the first interference light.

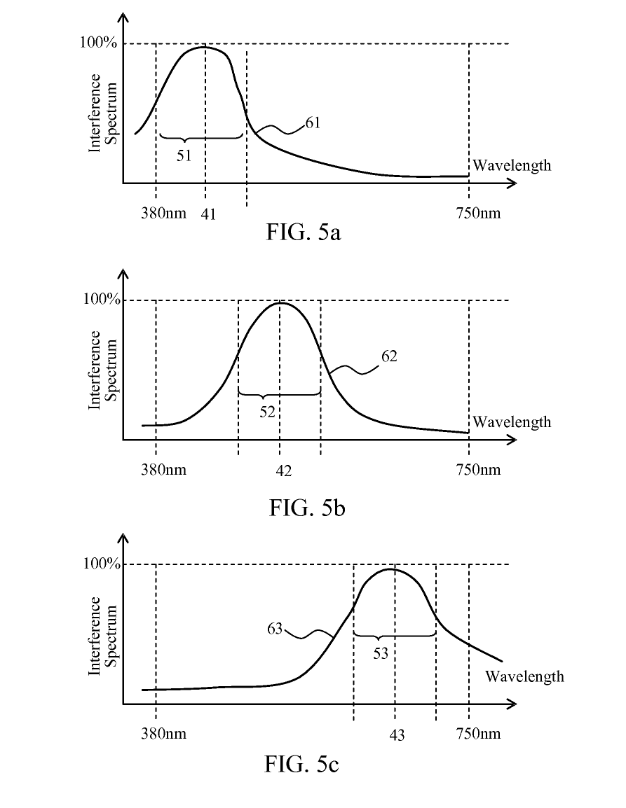

FIG. 5a illustrates spectrum 61 of the first interference light produced by the first conductive reflector 210. As shown in this figure, the spectrum 61 covers over visible spectrum (typically defined from 380 to 750 nm). Main power of the spectrum 61 is concentrated within the first interference band 51 centered by the first interference wavelength 41 close to 420 nm, which is the absorbance spectrum of yellow.

Meanwhile, the second conductive reflector 220 comprises a second high reflecting element 221 and a second low reflecting element 222, electrically connected to the driving circuitry 290, tiled in a planar configuration perpendicular to the incident direction 21 and vertically spaced in a second spacing 32 equal to n*[λ₂/4], wherein λ₂ is a second interference wavelength 42 centering the second interference band 52 and n is an odd integer. Thus, the second conductive reflector 220 through the second high reflecting element 221 and the second low reflecting element 222, produces destructive interference of the reflected portions to the incident light 20 of bandwidth defined by the second interference band 52 so as to produce the second interference light.

FIG. 5b illustrates spectrum 62 of the second interference light produced by the second conductive reflector 220. As shown in this figure, the spectrum 62 covers over visible spectrum (typically defined from 380 to 750 nm). Main power of the spectrum 62 is concentrated within the second interference band 52 centered by the second interference wavelength 42 close to 530 nm, which is the absorbance spectrum of magenta.

Similarly, the third conductive reflector 230 comprises a third high reflecting element 231 and a third low reflecting element 232, electrically connected to the driving circuitry 290, tiled in a planar configuration perpendicular to the incident direction 21 and vertically spaced in a third spacing 33 equal to p*[λ₃/4], wherein λ₃ is a third interference wavelength 43 centering the third interference band 53 and p is an odd integer. Thus, the third conductive reflector 230 through the third high reflecting element 231 and the third low reflecting element 232, produces destructive interference of the reflected portions to the incident light 20 of bandwidth defined by the third interference band 53 so as to produce the third interference light.

FIG. 5c illustrates spectrum 63 of the third interference light produced by the second conductive reflector 230. As shown in this figure, the spectrum 63 covers over visible spectrum (typically defined from 380 to 750 nm). Main power of the spectrum 63 is concentrated within the third interference band 53 centered by the third interference wavelength 43 close to 640 nm, which is the absorbance spectrum of cyan.

Specifically, as shown in FIG. 1, the first high reflecting element 211 and the first low reflecting element 212 are both directly electrically connected to the driving circuitry 290; the second high reflecting element 221 and the second low reflecting element 222 are both directly electrically connected to the driving circuitry 290; and the third high reflecting element 231 and the third low reflecting element 232 are both directly electrically connected to the driving circuitry 290.

When the driving circuitry 290 electrically charges the first high reflecting element 211 with the first low reflecting element 212, the second high reflecting element 221 with the second low reflecting element 222, and the third high reflecting element 231 with the third low reflecting element 232 individually, the liquid crystal molecules of the planar liquid crystal cell 150 will be twisted so as to allow the first interference light, the second interference light and the third interference light to passing through transparent conductive layer 110 and irradiate out of the transparent substrate 100 so as to form colorful image. The driving circuitry 290 is either completely configured into the backplane substrate 200 as for conventional liquid crystal on silicon (LCOS) display, or partially as for large panel LCD based on thin film transistor and glass substrate.

FIG. 2 is a cross sectional view of the colored liquid crystal display 10 according to another embodiment of the present invention. In this embodiment, the basic planar constituents and configuration of the colored liquid crystal display 10 are the same, except that the structures of conductive reflectors as follows:

In the present embodiment, the first conductive reflector 210 includes a first top conductive reflecting plate 215 and a first bottom conductive reflecting plate 216, electrically connected to the driving circuitry 290, configured in a vertically aligned and stacked arrangement both perpendicular to the incident direction 21 and vertically spaced in a first spacing 31 equal to m*[λ₁/4], wherein λ₁ is a first interference wavelength 41 centering the first interference band 51 and m is an odd integer.

The first top conductive reflecting plate 215 reflects part (substantially close to 50%) of the total incident light 20 and transmits the other part of the total incident light 20 to the first bottom conductive reflecting plate 216, and then the first bottom conductive reflecting plate 216 reflects the transmitted light. As they are vertically spaced in a first spacing 31, destructive interference is produced to form the first interference light of the first interference band 51 as shown in FIG. 5a.

The second conductive reflector 220 includes a second top conductive reflecting plate 225 and a second bottom conductive reflecting plate 226, electrically connected to the driving circuitry 290, configured in a vertically aligned and stacked arrangement both perpendicular to the incident direction 21 and vertically spaced in a second spacing 32 equal to n*[λ₂/4], wherein λ₂ is a second interference wavelength 42 centering the second interference band 52 and n is an odd integer.

The second top conductive reflecting plate 225 reflects part (substantially close to 50%) of the total incident light 20 and transmits the other part of the total incident light 20 to the second bottom conductive reflecting plate 226, and then the second bottom conductive reflecting plate 226 reflects the transmitted light. As they are vertically spaced in a second spacing 32, destructive interference is produced to form the first interference light of the second interference band 52 as shown in FIG. 5b.

The third conductive reflector 230 includes a third top conductive reflecting plate 235 and a third bottom conductive reflecting plate 236, electrically connected to the driving circuitry 290, configured in a vertically aligned and stacked arrangement both perpendicular to the incident direction 21 and vertically spaced in a third spacing 33 equal to p*[λ₃/4], wherein λ₃ is a third interference wavelength 43 centering the third interference band 53 and p is an odd integer.

The third top conductive reflecting plate 235 reflects part (substantially close to 50%) of the total incident light 20 and transmits the other part of the total incident light 20 to the third bottom conductive reflecting plate 236, and then the third bottom conductive reflecting plate 236 reflects the transmitted light. As they are vertically spaced in a third spacing 33, destructive interference is produced to form the third interference light of the third interference band 53 as shown in FIG. 5c.

Specifically, as shown in FIG. 2, the first top conductive reflecting plate 215 and the first bottom conductive reflecting plate 216 are both directly electrically connected to the driving circuitry 290; the second top conductive reflecting plate 225 and the second bottom conductive reflecting plate 226 are both directly electrically connected to the driving circuitry 290; and the third top conductive reflecting plate 235 and the third bottom conductive reflecting plate 236 are both directly electrically connected to the driving circuitry 290.

The first top conductive reflecting plate 215 and the first bottom conductive reflecting plate 216 jointly form a first planar capacitor 241, as separated by vacuum, air or a dielectric layer. The same are applied to the second top conductive reflecting plate 225 and the second bottom conductive reflecting plate 226 as a second planar capacitor 242, and the third top conductive reflecting plate 235 and the third bottom conductive reflecting plate 236 as a third planar capacitor 243, also separated by vacuum, air or dielectric layers. The dielectric layers, as the first thin transparent spacer 217, the second thin transparent spacer 227 and third thin transparent spacer 237 shown in FIG. 2, are made from any or combination of silicon oxide, silicon nitride, silicon carbide, silicon oxynitride, silicon carbon oxynitride, titanium oxide, tantalum oxide, tantalum nitride and hafnium oxide. Specifically, the first thin transparent spacer 217 is sandwiched between the first top conductive reflecting plate 215 and the first bottom conductive reflecting plate 216, the second thin transparent spacer 227 is sandwiched between the second top conductive reflecting plate 225 and the second bottom conductive reflecting plate 226, and the third thin transparent spacer 237 is sandwiched between the third top conductive reflecting plate 235 and the third bottom conductive reflecting plate 236.

Very commonly to LCD and semiconductor industry, reflective metals and alloys, including aluminum, titanium, copper, silver, platinum and gold as well as their alloys, are suitable candidates for fabricating the first, second and third conductive reflectors, 210, 220 and 230, and in particular, their constituents. Those constituents include the first, second and third high reflecting elements, 211, 221 and 231, and the first, second and third low reflecting elements, 212, 222 and 232, in the one embodiment and the first, second and third top conductive reflecting plates, 215, 225 and 235, and the first, second and third bottom conductive reflecting plates, 216, 226 and 236; all of them are made from any or combination of those reflective metals and their alloys.

As shown in FIG. 1 and FIG. 2, the transparent substrate 100 may further include a top alignment layer 120 and the backplane substrate 200 further includes a bottom alignment layer 204. The top alignment layer 120 and the bottom alignment layer 204 physically sandwich and align the planar liquid crystal cell 150 for setting the initial alignment direction of liquid crystal molecules. Specifically, the planar liquid crystal cell 150 is directly sandwiched between two liquid crystal alignment films, one of the liquid crystal alignment films is a top alignment layer 120 placed adherently underneath the transparent conductive layer 110 opposite to the transparent substrate 100, the other one of the liquid crystal alignment films is a bottom alignment layer 204 above the backplane substrate 200. The top and bottom alignment layers, 120 and 204, are made from any or combination of polyimide, silicon oxide, silicon nitride, transparent carbon, platinum and gold.

As physical isolation with the bottom alignment layer 204, a transparent protective layer 205 may be further disposed between the bottom alignment layer 204 and each of the first conductive reflector 210, the second conductive reflector 220 and the third conductive reflector 230. The transparent protective layer 205 is made from any of combination of polyimide, silicon oxide, silicon nitride and transparent carbon.

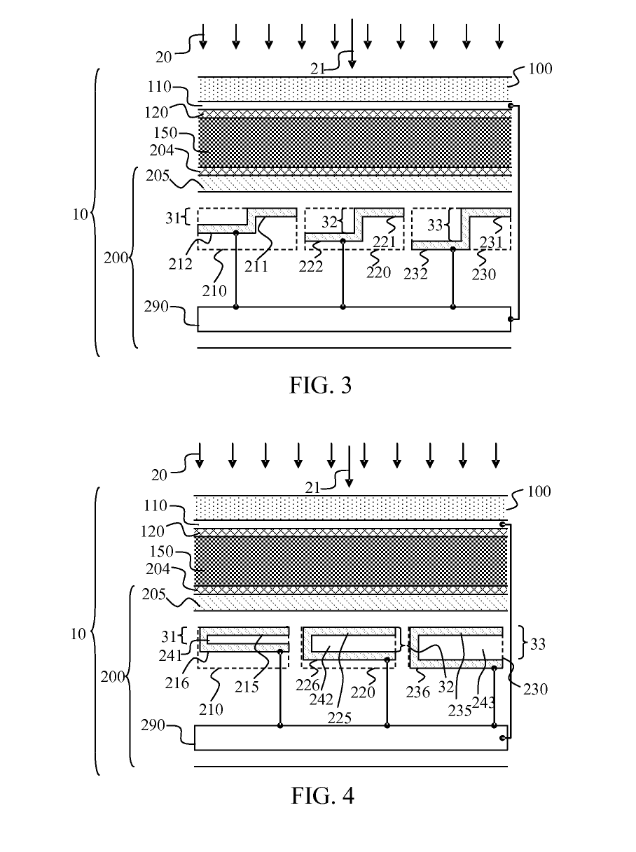

FIG. 3 is a cross sectional view of an improved structure of the colored liquid crystal display shown in FIG. 1. As shown in this figure, the first high reflecting element 211 and the first low reflecting element 212 are electrically connected at their adjacent edges, the first low reflecting element 212 is directly electrically connected to the driving circuitry 290, and the first high reflecting element 211 is indirectly electrically connected to the driving circuitry 290 via the first low reflecting element 212; the second high reflecting element 221 and the second low reflecting element 222 are electrically connected at their adjacent edges, the second low reflecting element 222 is directly electrically connected to the driving circuitry 290 and the second high reflecting element 221 is indirectly electrically connected to the driving circuitry 290 via the second low reflecting element 222; and the third high reflecting element 231 and the third low reflecting element 232 are electrically connected at their adjacent edges, the third low reflecting element 232 is directly electrically connected to the driving circuitry 290 and third high reflecting element 231 is indirectly electrically connected to the driving circuitry 290 via the third low reflecting element 232. When the driving circuitry 290 is performing charging, electrical charge is first applied to the first low reflecting element 212, the second low reflecting element 222, and the third low reflecting element 232 individually, and then is transferred and applied to the first high reflecting element 211, the second high reflecting element 221 and the third high reflecting element 231.

FIG. 4 is a cross sectional view of an improved structure of the colored liquid crystal display shown in FIG. 2. As shown in this figure, the first top conductive reflecting plate 215 and the first bottom conductive reflecting plate 216 are electrically connected at their same-side edges, the first bottom conductive reflecting plate 216 is directly electrically connected to the driving circuitry 290, and the first top conductive reflecting plate 215 is indirectly electrically connected to the driving circuitry 290 via the first bottom conductive reflecting plate 216; the second top conductive reflecting plate 225 and the second bottom conductive reflecting plate 226 are electrically connected at their same-side edges, the second bottom conductive reflecting plate 226 is directly electrically connected to the driving circuitry 290, and the second top conductive reflecting plate 225 is indirectly electrically connected to the driving circuitry 290 via the second bottom conductive reflecting plate 226; and the third top conductive reflecting plate 235 and the third bottom conductive reflecting plate 236 are electrically connected at their same-side edges, the third bottom conductive reflecting plate 236 is directly electrically connected to the driving circuitry 290 and the third top conductive reflecting plate 235 is indirectly electrically connected to the driving circuitry 290 via the third bottom conductive reflecting plate 236. When the driving circuitry 290 is performing charging, electrical charge is first applied to the first bottom conductive reflecting plate 216, the second bottom conductive reflecting plate 226, and the third bottom conductive reflecting plate 236, individually, and then is transferred and applied to the first top conductive reflecting plate 215, the second top conductive reflecting plate 225 and the third top conductive reflecting plate 235.

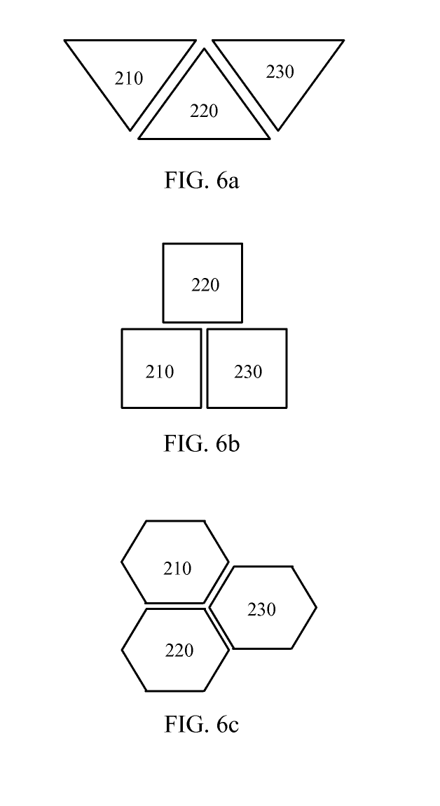

FIGS. 6a, 6b and 6c are top views of the conductive reflectors of the colored liquid crystal display 10 in the some embodiments of the present invention, illustrating some of their valid spatial shapes and associated tiling. As employed onto the flat panel display application, the conductive reflectors, 210, 220 and 230, are grouped first and then duplicated in a regularly tiled planar array. The individual constituent conductive reflectors, 210, 220 and 230, may be configured in a regular and adequate shape to forming the regularly tiled planar array. Typically as disclosed and used in industrial practice in the regular flat panel display panels, the first, second and third conductive reflectors, 210, 220 and 230, are optionally shaped in triangles as shown in FIG. 6a, squares as shown in FIG. 6b and hexagons as shown in FIG. 6c, besides others including rectangles, octagons and circles.

Finally, it should be understood that the above embodiments are only used to explain, but not to limit the technical solution of the present invention. In despite of the detailed description of the present invention with referring to above preferred embodiments, it should be understood that various modifications, changes or equivalent replacements can be made by those skilled in the art without departing from the scope of the present invention and covered in the claims of the present invention.

What is claimed is:

1. A colored liquid crystal display, in an order of vertically receiving an incident light in an incident direction, comprising: a transparent substrate, a transparent conductive layer, a planar liquid crystal cell and a backplane substrate; the backplane substrate comprises:
a first conductive reflector, a second conductive reflector and a third conductive reflector, tiled in a planar arrangement perpendicular to the incident direction, adapted for reflecting the incident light passing through the transparent substrate and forming a first interference light in a first interference band, a second interference light in a second interference band, and third interference light in a third interference band respectively; and
a driving circuitry electrically connected to the transparent conductive layer, the first conductive reflector, the second conductive reflector and the third conductive reflector, adapted for electrically charging the transparent conductive layer and each of the first conductive reflector, the second conductive reflector and the third conductive reflector individually and driving liquid crystal molecules in the planar liquid crystal cell to twist accordingly so as to allow the first interference light, the second interference light and the third interference light to irradiate out of the transparent substrate.

2. The colored liquid crystal display according to claim 1, wherein:
the first conductive reflector comprises a first high reflecting element and a first low reflecting element, electrically connected to the driving circuitry, tiled in a planar configuration perpendicular to the incident direction and vertically spaced in a first spacing equal to m*[λ₁/4], wherein λ₁ is a first interference wavelength centering the first interference band and m is an odd integer;
the second conductive reflector comprises a second high reflecting element and a second low reflecting element, electrically connected to the driving circuitry, tiled in a planar configuration perpendicular to the incident direction and vertically spaced in a second spacing equal to n*[λ₂/4], wherein λ₂ is a second interference wavelength centering the second interference band and n is an odd integer; and
the third conductive reflector comprises a third high reflecting element and a third low reflecting element, electrically connected to the driving circuitry, tiled in a planar configuration perpendicular to the incident direction and vertically spaced in a third spacing equal to p*[λ₃/4], wherein λ₃ is a third interference wavelength centering the third interference band and p is an odd integer.

3. The colored liquid crystal display according to claim 2, wherein:
the first high reflecting element and the first low reflecting element are both directly electrically connected to the driving circuitry;
the second high reflecting element and the second low reflecting element are both directly electrically connected to the driving circuitry;
the third high reflecting element and the third low reflecting element are both directly electrically connected to the driving circuitry.

4. The colored liquid crystal display according to claim 2, wherein:
the first high reflecting element and the first low reflecting element are electrically connected at their adjacent edges, the first low reflecting element is directly electrically connected to the driving circuitry, and the first high reflecting element is indirectly electrically connected to the driving circuitry via the first low reflecting element;
the second high reflecting element and the second low reflecting element are electrically connected at their adjacent edges, the second low reflecting element is directly electrically connected to the driving circuitry and the second high reflecting element is indirectly electrically connected to the driving circuitry via the second low reflecting element;
the third high reflecting element and the third low reflecting element are electrically connected at their adjacent edges, the third low reflecting element is directly electrically connected to the driving circuitry and third high reflecting element is indirectly electrically connected to the driving circuitry via the third low reflecting element.

5. The colored liquid crystal display according to claim 2, wherein the first high reflecting element and the first low reflecting element, the second high reflecting element and the second low reflecting element and the third high reflecting element and the third low reflecting element are made of any or combination of reflective metals including aluminum, titanium, copper, silver, platinum and gold.

6. The colored liquid crystal display according to claim 1, wherein:
the first conductive reflector comprises a first top conductive reflecting plate and a first bottom conductive reflecting plate, electrically connected to the driving circuitry, configured in a vertically aligned and stacked arrangement both perpendicular to the incident direction and vertically spaced in a first spacing equal to m*[λ₁/4], wherein λ₁ is a first interference wavelength centering the first interference band and m is an odd integer;
the second conductive reflector comprises a second top conductive reflecting plate and a second bottom conductive reflecting plate, electrically connected to the driving circuitry, configured in a vertically aligned and stacked arrangement both perpendicular to the incident direction and vertically spaced in a second spacing equal to n*[λ₂/4], wherein λ₂ is a second interference wavelength centering the second interference band and n is an odd integer; and
the third conductive reflector comprises a third top conductive reflecting plate and a third bottom conductive reflecting plate, electrically connected to the driving circuitry, configured in a vertically aligned and stacked arrangement both perpendicular to the incident direction and vertically spaced in a third spacing equal to p*[λ₃/4], wherein λ₃ is a third interference wavelength centering the third interference band and p is an odd integer.

7. The colored liquid crystal display according to claim 6, wherein:
the first top conductive reflecting plate and the first bottom conductive reflecting plate are both directly electrically connected to the driving circuitry;
the second top conductive reflecting plate and the second bottom conductive reflecting plate are both directly electrically connected to the driving circuitry;
the third top conductive reflecting plate and the third bottom conductive reflecting plate are both directly electrically connected to the driving circuitry.

8. The colored liquid crystal display according to claim 6, wherein:
the first top conductive reflecting plate and the first bottom conductive reflecting plate are electrically connected at their same-side edges, the first bottom conductive reflecting plate is directly electrically connected to the driving circuitry, and the first top conductive reflecting plate is indirectly electrically connected to the driving circuitry via the first bottom conductive reflecting plate;
the second top conductive reflecting plate and the second bottom conductive reflecting plate are electrically connected at their same-side edges, the second bottom conductive reflecting plate is directly electrically connected to the driving circuitry, and the second top conductive reflecting plate is indirectly electrically connected to the driving circuitry via the second bottom conductive reflecting plate;
the third top conductive reflecting plate and the third bottom conductive reflecting plate are electrically connected at their same-side edges, the third bottom conductive reflecting plate is directly electrically connected to the driving circuitry and the third top conductive reflecting plate is indirectly electrically connected to the driving circuitry via the third bottom conductive reflecting plate.

9. The colored liquid crystal display according to claim 6, wherein the first top conductive reflecting plate and the first bottom conductive reflecting plate, the second top conductive reflecting plate and the second bottom conductive reflecting plate, the third top conductive reflecting plate and the third bottom conductive reflecting plate are made of any or combination of reflective metals including aluminum, titanium, copper, silver, platinum and gold.

10. The colored liquid crystal display according to claim 6, wherein a first thin transparent spacer is sandwiched between the first top conductive reflecting plate and the first bottom conductive reflecting plate to form a first planar capacitor, a second thin transparent spacer is sandwiched between the second top conductive reflecting plate and the second bottom conductive reflecting plate to form a second planar capacitor, and a third thin transparent spacer is sandwiched between the third top conductive reflecting plate and the third bottom conductive reflecting plate to form a third planar capacitor.

11. The colored liquid crystal display according to claim 10, wherein the first thin transparent spacer, the second thin transparent spacer and third thin transparent spacer are made from any of combination of silicon oxide, silicon nitride, silicon carbide, silicon oxynitride, silicon carbon oxynitride, titanium oxide, tantalum oxide, tantalum nitride and hafnium oxide.

12. The colored liquid crystal display according to claim 1, wherein the backplane substrate further comprises a transparent protective layer disposed between the bottom alignment layer and each of the first conductive reflector, the second conductive reflector and the third conductive reflector.

13. The colored liquid crystal display according to claim 12, wherein the transparent protective layer is made from any or combination of polyimide, silicon oxide, silicon nitride and transparent carbon.

14. The colored liquid crystal display according to claim 1, wherein the transparent substrate further comprises a top alignment layer and the backplane substrate further comprises a bottom alignment layer, the top alignment layer and the bottom alignment layer physically sandwich and align the planar liquid crystal cell.

15. The colored liquid crystal display according to claim 14, wherein the top alignment layer and the bottom alignment layer are made from any or combination of polyimide, silicon oxide, silicon nitride, transparent carbon, platinum and gold.

16. The colored liquid crystal display according to claim 1, wherein the first interference band, the second interference band and the third interference band correspond to absorption spectra of cyan, yellow and magenta, respectively.

17. The colored liquid crystal display according to claim 1, wherein the transparent conductive layer is made of indium tin oxide (ITO).

18. The colored liquid crystal display according to claim 1, wherein a cross sectional shape perpendicular to the incident direction of each of the first conductive reflector, the second conductive reflector and the third conductive reflector is configured with a selective planar shape from triangle, square, rectangle, hexagon, octagon and circle.
